(19) United States
(12) Patent Application Publication
(10) Pub. No.: US 2004/0139042 A1
(43) Pub. Date: Jul. 15, 2004

(54) System and method for improving data analysis through data grouping

(76) Inventors: Andrew L. Schirmer, Andover, MA (US); Joann Ruvolo, San Jose, CA (US); Michael Muller, Medford, MA (US)

Correspondence Address: BROWN, RAYSMAN, MILLSTEIN, FELDER & STEINER LLP, 900 THIRD AVENUE, NEW YORK, NY, 10022, US

(21) Appl. No.: 10/335,260

(22) Filed: Dec. 31, 2002

(51) Int. Cl. G06F 7/00

(52) U.S. Cl. 707/1

(57) ABSTRACT

The invention relates generally to analysis of electronic data. More particularly, the invention provides a computerized method for grouping data objects to improve data analysis, the method comprising identifying application data objects having similar content, comprising decomposing a plurality of application data objects created by more than one application program and clustering the application data objects to identify elements in the application data objects having similar content, the identifying comprising parsing each decomposed application data object of the plurality of application data objects into one or more tokens and representing each application data object as a vector comprising a combination of some or all of the one or more tokens; labeling some or all of the application data objects according to identified elements; and aggregating related application data objects.

### BACKGROUND OF THE INVENTION

The invention disclosed herein relates generally to data analysis techniques and more particularly to selectively grouping related data objects from disparate applications for improving data analysis.

Large amounts of data are exchanged in existing computer systems, however, current data mining techniques only reveal limited amounts of valuable information. For example, Lotus Discovery Server is a knowledge management system that attempts to derive knowledge about people's expertise by analyzing the contents of their e-mail documents. Typically, the contents of each e-mail document is evaluated separately and then matched against a set of existing categories of information. If there is a match, the e-mail document can be denoted as belonging to that category, and the author of the e-mail document also ascribed some value of-expertise for that category. An embodiment of such a system is described in application Ser. No. 10/044,921, titled “SYSTEM AND METHOD FOR MINING A USER'S ELECTRONIC MAIL MESSAGES TO DETERMINE THE USER'S AFFINITIES” which is hereby incorporated herein by reference in its entirety.

One problem with such systems is that the text of e-mail documents and other similar application data objects is very often sparse and thus hard to categorize. E-mail documents, for example, are often replies to previous documents or communications, and as such lack the complete context of the previous discussion(s). Trying to extract meaning from such application data items without considering the entire context of the information across multiple application data items is difficult if not impossible.

Further, many e-mails and other documents are not directly associated with related application data objects. For example, related e-mails are not always part of the same thread or not direct replies to each other and thus not easily located. In addition to e-mail, other similar types of application data objects such as meeting notes and agenda items also present little, if any, information linking them to other related application data objects. For example, meeting notes and agenda items often relate to, but are not directly associated with other data objects such as text files, slide shows, and other types of work product files. Further, even when application data objects do provide information regarding other related application data objects, the information is generally limited to application data items of the same type such as e-mails or to other application data objects generated by the same application such as Lotus Notes items.

There is thus a need for methods, systems, and software products to identify and group related application data items generated by heterogeneous applications.

### SUMMARY OF THE INVENTION

The present invention addresses, among other things, the problems discussed above identifying related application data items.

In accordance with some aspects of the present invention, computerized methods are provided for grouping data objects to improve data analysis, the methods comprising identifying application data objects having similar content, comprising decomposing a plurality of application data objects associated with more than one application type, and clustering the application data objects to identify elements in the application data objects having similar content; labeling some or all of the application data objects according to identified elements; and aggregating related application data objects.

According to one embodiment of the invention, identifying the application data objects comprises parsing each decomposed application data object of the plurality of application data objects into one or more tokens and representing each application data object as a vector comprising a combination of some or all of the one or more tokens. In some embodiments, representing each application data object as a vector comprises removing some of the tokens in the application data object before representing the application data object as a vector. In other embodiments, removing some tokens comprises removing tokens appearing in a percentage of all application data objects which is below a first percentage or above a second percentage. In some embodiments, representing each application data object as a vector comprises representing all tokens in the application data object in the vector. In some embodiments, representing each application data object as a vector comprises weighting each token in the vector. In some embodiments, weighting each token comprises computing the weight of a each token as the frequency of occurrence of the token in the application data object divided by the largest frequency of occurrence for any token in the application data object. In some embodiments, weighting each token comprises computing the weight of each token as the frequency. In some embodiments, vectors are normalized. In some embodiments, a vector space model comprising a matrix having a plurality of rows and a plurality of columns is generated, wherein the number of rows equals the number of ADOs represented by vectors and the number of columns equals the number of tokens contained in the vectors.

In some embodiments, labeling comprises selecting some of the identified elements according to a predefined criteria.

In some embodiments, selecting some of the identified elements comprises identifying elements which are nouns or noun phrases and selecting the elements so identified. In some embodiments, aggregating related application data objects comprises aggregating application data objects sharing similar labels. In some embodiments, aggregating related application data objects comprises concatenating related application data objects into a single data object. In some embodiments, aggregating related application data objects comprises associating information with an application data object identifying other application data objects to which the application data object is related.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram showing a computer system for processing and clustering application data items in accordance with one embodiment of the present invention;

FIG. 2 is a flow chart showing a method of grouping application data items in accordance with one embodiment of the invention;

FIG. 3 is a flow diagram showing one process performed by the system of FIG. 1 for decomposing and clustering application data items in accordance with the present invention; and

FIGS. 4A-4B is a flow chart showing a method of processing, clustering, and aggregating application data items in accordance with one embodiment of the invention.

### DETAILED DESCRIPTION

In accordance with the invention, automatically clustering the tokens of application data objects identifies data objects with similar content. Extracting statistically significant labels from the tokens identifies the topics associated with the clusters. These labels then act as a content summary enabling related application data objects generated by disparate applications (“ADOs”) to be grouped together for further analysis. Thus, analyzing an entire grouping of related ADOs yields more valuable information than analyzing each ADO individually. For example, ADOs can be grouped to accord expertise to individuals according to ADO authorship, access, interaction, and other useful factors. As another example, an aggregation of related ADOs can be analyzed to determine topics of discussion or even simply to provide better organization of ADOs. The clustering process is further described herein.

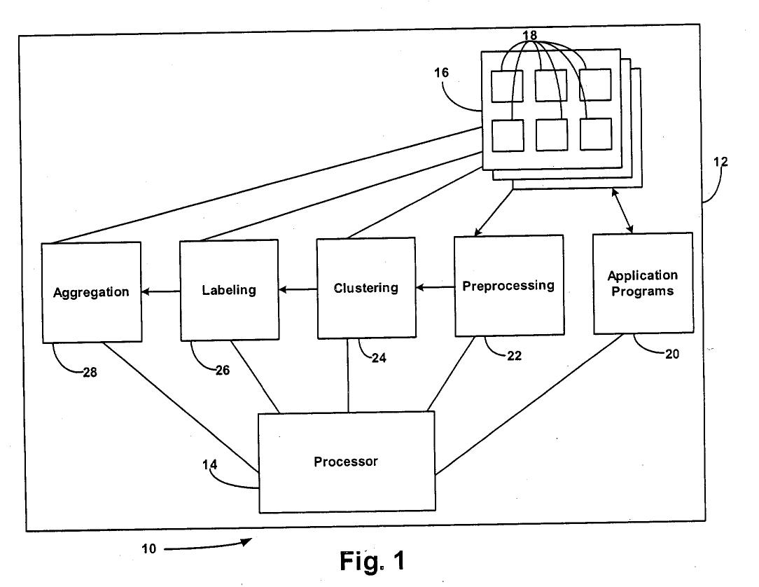

A system and method of preferred embodiments of the present invention are now described with reference to FIGS. 1-4B. Referring to FIG. 1, a system 10 of one embodiment of the present invention includes a computer system 12, which may be a personal computer, networked computers, or other conventional computer architecture. The system 10 includes a processor 14 and at least one data store 16 such as a database or other memory structure which may be stored in volatile memory, non-volatile memory, a hard disk, a network-attached storage device, or other storage media as known in the art. In some embodiments, the data store 16 may include multiple databases and other memory structures stored in multiple locations in a network computing environment.

In accordance with the present invention, a number of software programs or program modules or routines reside and operate on the computer system 12. These include application programs 20, a preprocessor 22, a clustering program 24, a labeler 26, and an aggregation engine 28. The application programs 20 may be any conventional application programs, such as Lotus Notes, Microsoft Office, vBulletin, GoldMine, Quicken, Quick Books, FileMaker, Act!, Project, and other application programs known in the art. The application programs 20 create application data objects 18 which are stored in the at least one data store 16. ADOs 18 include files and other data items generated by the application programs 20 such as email messages, calendar items, newsgroup or bulletin board threads, notes documents with response chains, to-do lists, meeting artifacts (including agenda items, minutes, action items, etc.), document files, multimedia files, and similar data items as known in the art.

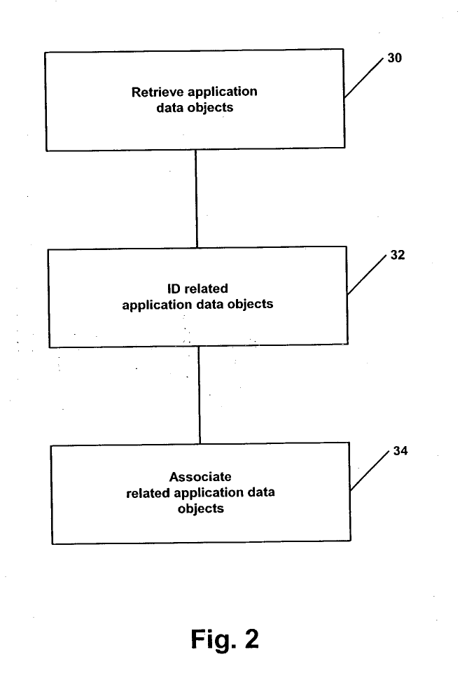

FIG. 2 presents a flow diagram showing a method of grouping application data items 18 in accordance with one embodiment of the invention. The system 10 collects data from the data store 16 and parses the data into individual application data objects 18, step 30. For example, the data store 16 might contain a single Exchange data file of multiple ADOs 18 such as e-mail messages, calendar items, meeting notes, to-do lists, and other similar items that would need to be parsed for processing by the system 10. The preprocessor 22 collects the data from the data store 16 by retrieving identifiable data types used by the system 10. For example, in some embodiments, the preprocessor 22 is programmed to identify and retrieve specific file types which can be processed by the system 10. The preprocessor 22 decomposes the data into individual ADOs 18 in several possible ways depending on the application. In one embodiment, ad hoc parsing techniques specific to the file format of the application programs 20 are used to identify each ADO 18 and write it to a separate file. In another embodiment, ADOs 18 generated by disparate applications are normalized and fields containing similar data types are modified for processing by the system 10. The system 10 uses data stored in the data store 16 or other memory specifying the file format or protocols or other useful information associated with ADOs 18 to be normalized. For example, ADOs 18 such as a calendar item, an e-mail item, a text file, a slide presentation, or other similar items might have their message bodies padded to a all equal a certain length for more efficient processing as known in the art.

The system 10 identifies related ADOs 18, step 32. ADOs 18 are passed from the preprocessor 22 to the clustering engine 24, which may be any clustering algorithm including conventional ones such as the k-means clustering algorithm described in L. Bottou and Y. Bengio, Convergence Properties of the K-Means Algorithm, in Advances in Neural Information Processing Systems 7, pages 585-592 (MIT Press 1995), which is hereby incorporated by reference into this application. Several examples of additional document clustering algorithms are described in the following two documents, which are also hereby incorporated by reference into this application. Douglas R. Cutting, David R. Karger, Jan O. Pedersen, John W. Tukey, Scatter/Gather: A Cluster-based Approach to Browsing Large Document Collections. In Proceedings of the 15th Annual International ACM SIGIR Conference. Association for Computing Machinery. New York. June, 1992. Pages 318-329. Gerard Salton. Introduction to Modern Information Retrieval, (McGraw-Hill, New York. 1983).

The clustering engine 24 treats each ADO 18 as a separate document, and converts each document or ADO 18 to a feature vector. Features are the words used in the ADO 18, key phrases, and other attributes such as time, date, and author. In particular embodiments, the natural language parsing capabilities of the Textract™. information retrieval program available from IBM Corp. are used. Textract's ability to locate proper names is described in the following two articles, which are hereby incorporated by reference into this application: Yael Ravin and Nina Wacholder, Extracting Names from Natural-Language Text, IBM Research report RC 20338, T. J. Watson Research Center, IBM Research Division, Yorktown Heights, N.Y., April 1997; and Nina Wacholder, Yael Ravin, and Misook Choi, Disambiguation of proper Names in Text, Proceedings of the Fifth Conference on Applied Natural Language Processing, pages 202-208, Washington D.C., March 1997. In some embodiments, Textract may be used to identify key noun phrases.

The feature vector for an ADO 18 has a non-zero weight for every feature present in the ADO 18. The weight is based on the frequency of the feature in the document, its type (e.g., whether an author field, word, or phrase), and its distribution over the collection. Once an ADO 18 is represented as a feature vector, a similarity measure is defined on ADOs 18. The similarity measure is then used to group related ADOs 18.

The labeling engine 26 selects the most statistically significant features to label as clusters. Noun phrases, for example, may be advantageously selected as labels because they are typically more meaningful to users. In other embodiments, verb phrases or other useful content types may be selected as labels. The aggregation engine 28 organizes the labels received from the labeling engine 26 and associates related ADOs 18, step 34, as further described herein.

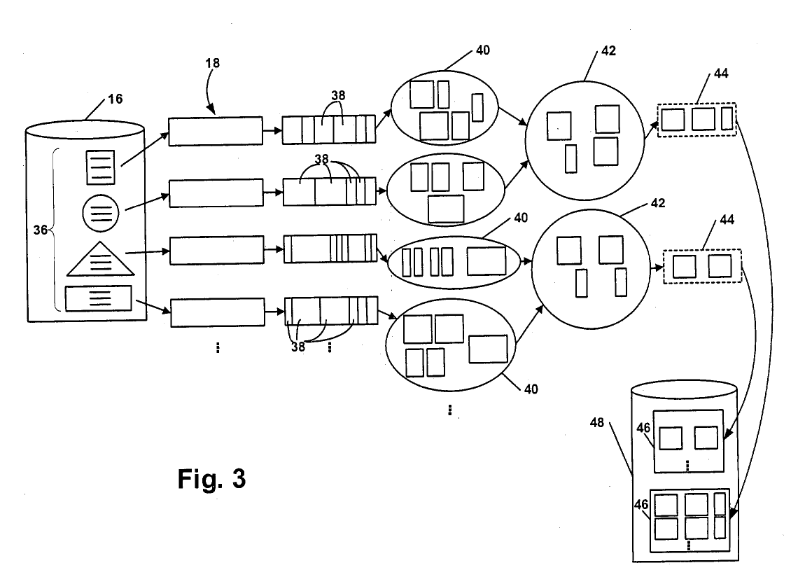

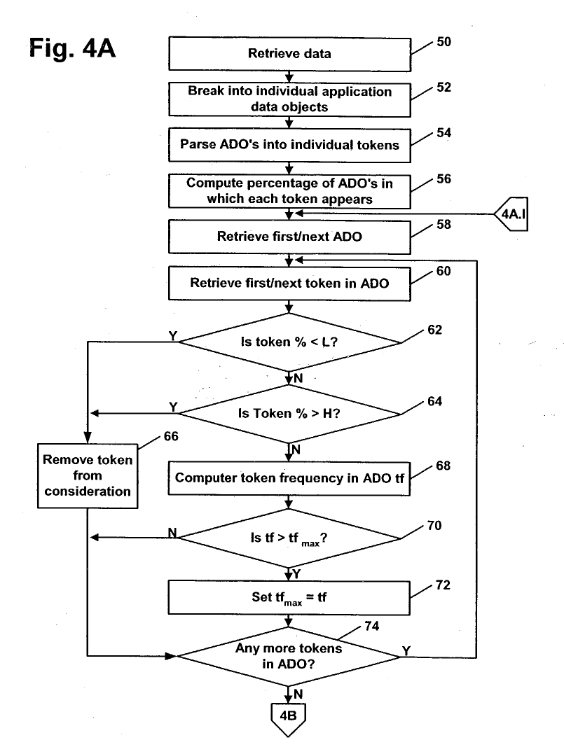

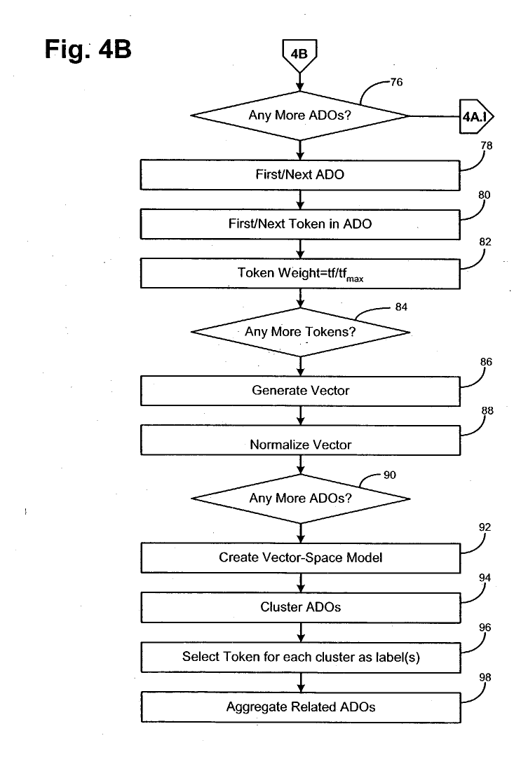

Particular methods for processing and clustering application data objects 18 are now described with reference to the flow diagram of FIG. 3 and the flow charts in FIGS. 4A-4B. Data 36 (FIG. 3) is retrieved from the data store 16, step 50 (FIG. 4A), and the data 36 broken into separate application data objects 18, step 52. As previously described, ADOs 18 include files and other data items generated by disparate application programs 20. The ADOs 18 are then parsed into individual tokens 38, step 54, the tokens 38 containing individual words, word phrases, numbers, dates, fields, variables, data structures, and other items useful for grouping related ADOs 18 according to the system 10. As previously described, tokens 38 may be normalized in some embodiments by padding fields and performing other normalization techniques for processing data items from disparate formats as known in the art. In some embodiments, normalized tokens 18 are stored in interim memory structures for further processing.

Some tokens 38 in each ADO 18 may be removed from consideration because they are less relevant or meaningful to users. Tokens 38 that appear in relatively very few ADOs 18 likely do not represent a truly relevant aspect of the discussion, and tokens 38 that appear in a large percentage of ADOs 18 are likely commonplace words such as articles. Thus, the preprocessor 22 computes the percentage of ADOs 18 in which each token 38 appears, step 56. Then, each ADO 18 is considered, step 58, and each token 38 in the ADO 18 is considered, step 60. For the given token 38, if the percentage associated with that token 38 is either less than a predefined lower limit percentage L, step 62, or higher than a predefined upper limit percentage H, step 64, the token 38 is removed from the ADO 18, step 66. Alternatively, all tokens 38 may be retained, and ADOs 18 may be subjected to a stop list, which filters the ADOs 18 to remove certain words known to have little value in information retrieval, such as a, an, but, the, or, etc.

For each remaining token 38, a token frequency t.function. is computed, step 68, as the frequency of the given token 38 in that ADO 18, and compared to t.function..sub.max, step 70, which is the largest token frequency of any term in the ADO 18, initially set to 0 for each ADO 18. If t.function. for a given token 38 exceeds the current value of t.function..sub.max for that ADO 18, then t.function..sub.max is set equal to t.function., step 72. Once all tokens 38 in the ADO 18 have been considered, the current value of t.function..sub.max will represent the maximum token frequency for the ADO 18.

When all tokens 38 in each ADO 18 have been considered, step 74, and all ADOs 18 considered, step 76 (FIG. 4B), each ADO 18 is represented as a vector in a vector-space model. Thus, each ADO 18 is considered, step 78, and each token 38 in a given ADO 18 considered, step 80. Each token 38 is given a weight in each ADO 18 according to the formula t.function./t.function..sub.max, step 82. Other possible formulas include a binary value (1 if the term occurs in the document, 0 if it does not), and a traditional t.function.idf measure where the frequency of the term in the ADO 18 is divided by the number of documents in the collection that contain the term.

If all tokens 38 have been assigned weights step 84, a vector is generated as the combination of the weighted tokens 18, step 86. Each vector is then normalized to a unit vector, i.e., a vector of length 1, step 88. This is accomplished, in accordance with standard linear algebra techniques, by dividing each token's 18 weight by the square root of the sum of the squares of the token weights of all tokens 18 in the vector.

When all ADOs 18 have been considered and converted into vectors, step 90, the vectors are converted to a vector space model, step 92, which is a matrix where the number of rows is equal to the number of ADOs 18 and the number of columns is equal to the number of tokens 38 retained to form the vector-space representation. This is referred to as the document-token matrix. The number of vectors to be clustered is equal to the number of ADOs 18. The matrix resulting from the preprocessing is sparse, i.e., very few of the cells in the document-token matrix are non-zeros.

The vectors or ADOs 18 are then clustered separately, step 94. This clustering can be performed in several conventional ways known to those of skill in the art, including in ways described in the Salton and Cutting references referred to above. The clustering results in a set of clusters 40 (FIG. 3) which may then be grouped into groups of clusters 42 based on similar content. This process of hierarchical clustering is accomplished by computing a centroid document, which is often a vector where each token weight is the average of the token weights for that token 38 for all vectors in the cluster 40. Each centroid is treated as a document, and each cluster 40 is represented as a centroid. The process of clustering is performed again on the centroid representing clusters 40, generating a new cluster 40 containing one or more old clusters 40. This process of hierarchical clustering may be performed a desired number of times or until a predefined criteria is reached.

The clusters 40 are then assigned labels 44 by selecting some of the tokens in the cluster 40 or cluster group 42, step 96. The labeling of document clusters 40 is known to those of skill in the art, and is described for example in pages 314-323 of Peter G. Anick and Shivakumar Vaithyanathan, Exploiting Clustering and Phrases for Context-based Information Retrieval, in Proceedings of the 20th International ACM SIGIR Conference, Association for Computing Machinery, July 1997, which document is hereby incorporated by reference into this application. The process of labeling ADO 18 clustering includes picking semantically meaningful and important words and phrases in each cluster 40, wherein words are considered important when they satisfy predefined statistical criteria similar to the generation of token weights.

Once labels 44 have been assigned, ADOs 18 containing similar labels are aggregated, step 98. In one embodiment, related ADOs 18 are aggregated by concatenating them into a single document or other unitary logical unit 46 and stored in an aggregation store 48. In another embodiment, related ADOs 18 are tracked using a data structure such as an array or other data structure suitable for storing data associating related arrays. In some embodiments, the labels 44 may be hyperlinked to documents containing the cluster group 42 information, such as through the use of HTML links or other navigation techniques. The cluster group 42 information may contain a list of the ADOs 18 in the group 42, members of the list being hyperlinked to the same ADO 18 in the data store 16. As a result, a user may quickly and easily navigate among related ADOs 18.

In some embodiments, the system 10 may also utilize application-specific information to determine related ADOs 18. For example, some email applications indicate when a particular message has been replied to and also contain a link to the reply. Threaded discussion groups also contain references to message posts which respond to other message posts. Items such as calendar items, items in to-do lists, e-mail invitations, journal entries, and other similar items are associated with each other in some programs such as Microsoft Outlook. Outlook journal entries and other data items are also associated, for example, with Microsoft Word files, Excel files, PowerPoint presentations, Visio files, and other file types to indicate, among other things, what files a user worked on during the day. This information is generally stored in data structures associated with or within the ADOs 18 and may be extracted to determine related ADOs 18 according to the invention.

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser or other application in an ASP context, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Screenshots presented and described herein can be displayed differently as known in the art to input, access, change, manipulate, modify, alter, and work with information.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A method for grouping data objects to improve data analysis, the method comprising:
identifying application data objects having similar content, comprising decomposing a plurality of application data objects associated with more than one application type and clustering the application data objects to identify elements in the application data objects having similar content;
labeling some or all of the application data objects according to identified elements; and
aggregating related application data objects.

2. The method of claim 1, wherein the identifying comprises parsing each decomposed application data object of the plurality of application data objects into one or more tokens and representing each application data object as a vector comprising a combination of some or all of the one or more tokens.

3. The method of claim 2, wherein representing each application data object as a vector comprises removing some of the tokens in the application data object before representing the application data object as a vector.

4. The method of claim 3, wherein removing some tokens comprises removing tokens appearing in a percentage of all application data objects which is below a first percentage or above a second percentage.

5. The method of claim 2, wherein representing each application data object as a vector comprises representing all tokens in the application data object in the vector.

6. The method of claim 2, wherein representing each application data object as a vector comprises weighting each token in the vector.

7. The method of claim 6, wherein weighting each token comprises computing the weight of a each token as the frequency of occurrence of the token in the application data object divided by the largest frequency of occurrence for any token in the application data object.

8. The method of claim 6, wherein weighting each token comprises computing the weight of each token as the frequency.

9. The method of claim 6, comprising normalizing each vector.

10. The method of claim 2, comprising generating a vector space model comprising a matrix having a plurality of rows and a plurality of columns, wherein the number of rows equals the number of ADOs represented by vectors and the number of columns equals the number of tokens contained in the vectors.

11. The method of claim 1, wherein labeling comprises selecting some of the identified elements according to a predefined criteria.

12. The method of claim 11, wherein selecting some of the identified elements comprises identifying elements which are nouns or noun phrases and selecting the elements so identified.

13. The method of claim 1, wherein aggregating related application data objects comprises aggregating application data objects sharing similar labels.

14. The method of claim 1, wherein aggregating related application data objects comprises concatenating related application data objects into a single data object.

15. The method of claim 1, wherein aggregating related application data objects comprises associating information with an application data object identifying other application data objects to which the application data object is related.

16. An article of manufacture comprising a computer readable medium containing a program which when executed on a computer causes the computer to perform a method for grouping data objects to improve data analysis, the method comprising:
identifying application data objects having similar content, comprising decomposing a plurality of application data objects associated with more than one application type and clustering the application data objects to identify elements in the application data objects having similar content;
labeling some or all of the application data objects according to identified elements; and
aggregating related application data objects.

17. The article of manufacture of claim 16, wherein the identifying comprises parsing each decomposed application data object of the plurality of application data objects into one or more tokens and representing each application data object as a vector comprising a combination of some or all of the one or more tokens;

18. The article of manufacture of claim 17, wherein representing each application data object as a vector comprises removing some of the tokens in the application data object before representing the application data object as a vector.

19. The article of manufacture of claim 17, wherein removing some tokens comprises removing tokens appearing in a percentage of all application data objects which is below a first percentage or above a second percentage.

20. The article of manufacture of claim 17, wherein representing each application data object as a vector comprises representing all tokens in the application data object in the vector.

21. The article of manufacture of claim 17, wherein representing each application data object as a vector comprises weighting each token in the vector.

22. The article of manufacture of claim 21, wherein weighting each token comprises computing the weight of a each token as the frequency of occurrence of the token in the application data object divided by the largest frequency of occurrence for any token in the application data object.

23. The article of manufacture of claim 21, wherein weighting each token comprises computing the weight of each token as the frequency.

24. The article of manufacture of claim 21, comprising normalizing each vector.

25. The article of manufacture of claim 17, comprising generating a vector space model comprising a matrix having a plurality of rows and a plurality of columns, wherein the number of rows equals the number of application data objects represented by vectors and the number of columns equals the number of tokens contained in the vectors.

26. The article of manufacture of claim 16, wherein labeling comprises selecting some of the identified elements according to a predefined criteria.

27. The article of manufacture of claim 26, wherein selecting some of the identified elements comprises identifying elements which are nouns or noun phrases and selecting the elements so identified.

28. The article of manufacture of claim 16, wherein aggregating related application data objects comprises aggregating application data objects sharing similar labels.

29. The article of manufacture of claim 16, wherein aggregating related application data objects comprises concatenating related application data objects into a single data object.

30. The article of manufacture of claim 16, wherein aggregating related application data objects comprises associating information with an application data object identifying other application data objects to which the application data object is related.
